(19) United States
(12) Patent Application Publication
(10) Pub. No.: US 2022/0179637 A1
(43) Pub. Date: Jun. 9, 2022

(54) Version Checking Apparatus, Version Checking System, and Version Checking Method

(71) Applicant: Hitachi, Ltd., Tokyo (JP)

(72) Inventors: Ashokkumar CHETTYMANI, Tokyo (JP); Kota IDEGUCHI, Tokyo (JP); Shugo MIKAMI, Tokyo (JP)

(21) Appl. No.: 17/457,277

(22) Filed: Dec. 2, 2021

(30) Foreign Application Priority Data
Dec. 7, 2020 (JP) 2020-202414

(51) Int. Cl. G06F 8/65; G06F 8/71

(52) U.S. Cl. CPC G06F 8/65; G06F 8/71

(57) ABSTRACT

A version checking apparatus that checks subject software version information, and easily decides whether or not the subject software version information matches version information of reference software having been found to have a vulnerability, e.g., even in a case of version information including a certain special character includes: an extracting section that extracts the subject software version information from subject software; a structuring section that generates subject software version structured information obtained by converting the subject software version information into a predetermined structural format by using a structuring rule; a checking section that decides a similarity of the subject software version structured information to reference software version structured information by comparing the subject software version structured information with the reference software version structured information; and a communication section that outputs a checking result representing the similarity of the subject software version structured information to the reference software version structured information.

### INCORPORATION BY REFERENCE

This application claims priority based on Japanese patent application, No. 2020-202414 filed on Dec. 7, 2020, the entire contents of which are incorporated herein by reference.

### BACKGROUND

The present disclosure relates to a version checking apparatus, a version checking system, and a version checking method.

In recent years, along with the advancement in information technologies, software products are used in apparatuses in various industries such as medical equipment, automobiles, or home electric appliances in addition to personal computers. These software products are updated to newer versions in some cases in order to remove malfunctions that are included in products at the time of initial shipping, solve vulnerabilities that are found after the shipping, add new functionalities, improve existing functionalities, and so on.

Particularly, in a case where a vulnerability of a software product is found, it is important to update the software product to the latest version in order to solve the vulnerability and guarantee the safety of data. Because of this, in a case where a vulnerability of a software product is found, it is necessary to identify software product versions that are to be affected by the vulnerability.

However, since there is not a common version name format of version information representing the versions of software products, and different formats are used between different vendors that provide the software products, between different types of product and so on, it becomes difficult to identify software product versions that are to be affected by a vulnerability in some cases.

Conventionally, there are several proposals having been made to identify software products that are to be affected by a particular vulnerability.

For example, Luis Alberto Benthin Sanguino and Rafael Uetz. 2017. “Software Vulnerability Analysis Using CPE and CVE.” ArXiv Preprint, ArXiv:1705.05347 (2017), hereinafter referred to as Non-patent Document 1, describes a technology by stating, “In this paper, we analyze the Common Platform Enumeration (CPE) dictionary and the Common Vulnerabilities and Exposures (CVE) feeds. These repositories are widely used in Vulnerability Management Systems (VMSs) to check for known vulnerabilities in software products. The analysis shows, among other issues, a lack of synchronization between both datasets that can lead to incorrect results output by VMSs relying on those datasets. To deal with these problems, we developed a method that recommends to a user a prioritized list of CPE identifiers for a given software product. The user can then assign (and, if necessary, adapt) the most suitable CPE identifier to the software so that regular (e.g., daily) checks can find known vulnerabilities for this software in the CVE feeds. Our evaluation of this method shows that this interaction is indeed necessary because a fully automated CPE assignment is prone to errors due to the CPE and CVE shortcomings.”

Non-patent Document 1 describes a method of identifying software products that are to be affected by a particular vulnerability by using a so-called string search technique.

However, the method described in Non-patent Document 1 is an identification method related to version information including only alphabet characters and numerical values, and does not take into consideration version information including special characters such as parentheses or an underscore.

In view of this, an object of the present disclosure is to provide version checking means that easily identifies a software product that needs a version update even in a case of version information including a certain special character by checking subject software version information, and generating a checking result representing a similarity of the subject software version information to reference information about a version having been found to have a vulnerability, for example.

### SUMMARY

In order to solve the problem described above, a representative one of a version checking apparatus of the present disclosure includes: an extracting section that extracts, from subject software which is a subject of version checking, subject software version information representing a software version of the subject software; a structuring section that generates subject software version structured information obtained by converting the subject software version information into a predetermined structural format by using a structuring rule that defines subdivision of a string on a basis of presence or absence of a predetermined character in the subject software version information; a checking section that decides a similarity of the subject software version structured information to reference software version structured information representing a reference software version in the structural format by comparing the subject software version structured information with the reference software version structured information; and a communication section that outputs a checking result representing the similarity of the subject software version structured information to the reference software version structured information.

According to the present disclosure, it is possible to provide version checking means that easily identifies a software product that needs a version update even in a case of version information including a certain special character by checking subject software version information, and generating a checking result representing a similarity of the subject software version information to reference information about a version having been found to have a vulnerability, for example.

Problems, configurations, and advantages other than those described above are made clear by the following explanation of modes for carrying out the invention.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a figure depicting an example of the hardware configuration of a computer system for implementing an embodiment of the present disclosure.

FIG. 2 is a figure depicting a version information table representing version information format types according to the embodiment of the present disclosure.

FIG. 3 is a figure depicting an example of the configuration of a version checking system according to the embodiment of the present disclosure.

FIG. 4 is a figure depicting an example of the logical configuration of a version checking apparatus according to the embodiment of the present disclosure.

FIG. 5 is a figure depicting an example of the flow of a structuring process according to the embodiment of the present disclosure.

FIG. 6 is a figure depicting an example in which the structuring process according to the embodiment of the present disclosure is applied to software version information, and software version structured information is generated.

FIG. 7 is a figure depicting an example of the flow of a version checking process for checking a software version according to the embodiment of the present disclosure.

FIG. 8 is a figure depicting a particular character handling table representing a method of handling cases where there is a particular character in a string in the version checking process according to the embodiment of the present disclosure.

FIG. 9 is a figure depicting specific examples of software version comparison in the version checking process according to the embodiment of the present disclosure.

### DESCRIPTION OF THE EMBODIMENTS

Hereinafter, an embodiment of the present invention is explained with reference to the figures. Note that the present invention is not limited by the embodiment. In addition, in the description of the figures, identical portions are depicted by being given identical reference characters.

As mentioned above, in a case where a vulnerability of a software product is found, it is important to update the software product to the latest version in order to solve the vulnerability, and guarantee the safety of data. Because of this, in a case where a vulnerability of a software product is found, it is necessary to identify software product versions that are to be affected by the vulnerability.

However, since there is not a common version name format of version information representing the versions of software products, and different formats are used between different vendors that provide the software products, between different types of product, and so on, it becomes difficult to identify software product versions that are to be affected by a vulnerability in some cases.

Whereas conventionally there are several proposals having been made to identify software products to be affected by a particular vulnerability, none of the conventional proposals take into consideration version information including special characters such as parentheses or an underscore, and the scope of application is limited.

For example, conventionally, so-called string comparison is known as a technique for deciding whether or not two strings match. In the string comparison, it is possible to decide whether or not a particular string completely matches another string (i.e. whether or not all the characters match), and particularly highly precise comparison results can be obtained about strings including only numerical values or strings including only alphabet characters.

It should be noted however that in a case of version information representing software versions, not only alphabet characters or numerical values, but also special characters such as parentheses or an underscore are included in many cases. Furthermore, since information about versions having been found to have a vulnerability is specified by a range in some cases, it is necessary to determine whether or not a string is within the specified range in order to decide whether or not a version with particular version information is to be affected by the vulnerability.

However, existing techniques like the string comparison do not support cases where alphabet characters, numerical values, special characters, and the like are mixedly present and that it is required to decide whether a version is within or outside a range, it is difficult to compare and check software versions by the existing techniques, and checking means suited for software versions is desired.

In view of this, the present disclosure relates to a technique that can identify a software product that needs a version update, even in a case of version information including a certain special character, by comparing check-subject software version information with reference information about a version having been found to have a vulnerability after the check-subject software version information is converted into a common structural format.

Software products according to the embodiment of the present disclosure mean application software that operate on certain computing devices such as personal computers, medical equipment, automobiles, or home electric appliances, and contribute to predetermined work and business tasks, and are not particularly limited in the present disclosure.

The common structural format according to the embodiment of the present disclosure is a common format for comparing subject software version information and reference software version information. In this structural format, a string to be software version information is subdivided on the basis of each character element included in the string.

After check-subject software version information and reference information about a version having been found to have a vulnerability are subdivided on the basis of each character element, and converted into information in the structural format, these subject software version information and reference software version information are compared with each other on the basis of each character element. Thereby, it is possible to decide a similarity of the subject software version information to the reference software version information. In a case where the similarity of the subject software version information to the reference software version information satisfies a predetermined criteria (e.g. in a case where the subject software version information and the reference software version information match), the subject software version information likely has a vulnerability similar to the vulnerability of the reference version information, and thus software with the subject software version information needs to be updated.

In this manner, according to the version checking according to the embodiment of the present disclosure, it is possible to easily identify software products that need a version update.

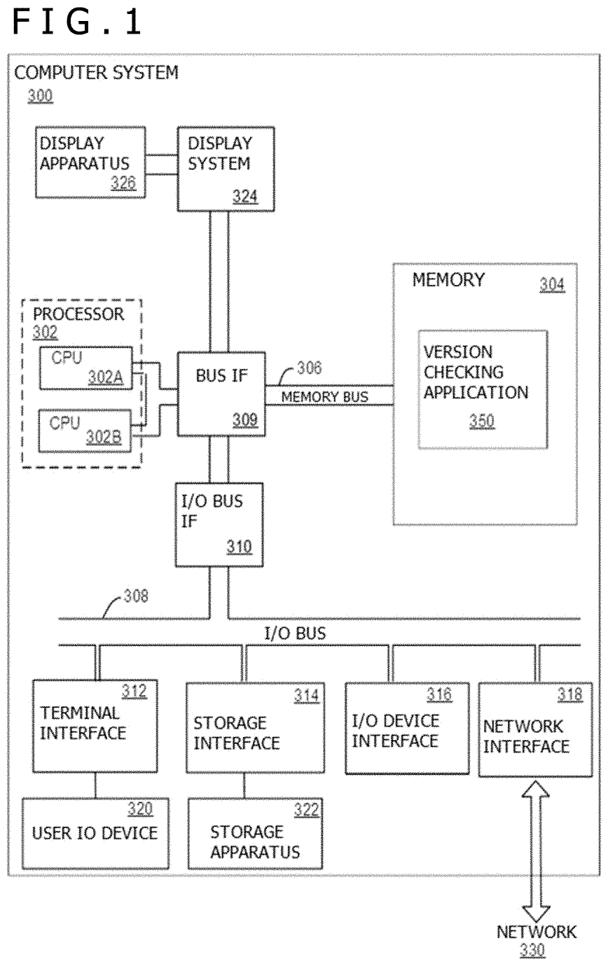

First, a computer system 300 for implementing the embodiment of the present disclosure is explained with reference to FIG. 1. Mechanisms and apparatuses in various embodiments disclosed in the present specification may be applied to any appropriate computing system. Main components of the computer system 300 include one or more processors 302, a memory 304, a terminal interface 312, a storage interface 314, an input/output (I/O) device interface 316, and a network interface 318. These components may be interconnected via a memory bus 306, an I/O bus 308, a bus interface unit 309, and an I/O bus interface unit 310.

The computer system 300 may include one or more general-purpose programmable central processing units (CPU) 302A and 302B that are collectively referred to as the processors 302. In an embodiment, the computer system 300 may include a plurality of processors, and in another embodiment, the computer system 300 may be a single CPU system. Each processor 302 may execute instructions stored on the memory 304, and include an on-board cache.

In an embodiment, the memory 304 may include a random access semiconductor memory, a storage apparatus, or a storage medium (either volatile or non-volatile) for storing data and programs. The memory 304 may store all or some of programs, modules, and data structures that implement functionalities explained in the present specification. For example, the memory 304 may store a version checking application 350. In an embodiment, the version checking application 350 may include instructions or descriptions for executing functionalities mentioned below on the processors 302.

In an embodiment, the version checking application 350 may be implemented by hardware via a semiconductor device, a chip, a logic gate, a circuit, a circuit card, and/or another physical hardware device, instead of a processor-based system or in addition to a processor-based system. In an embodiment, the version checking application 350 may include data other than instructions or descriptions. In an embodiment, a camera, a sensor, or another data input device (not depicted) may be provided to directly communicate with the bus interface unit 309, the processors 302, or other hardware of the computer system 300.

The computer system 300 may include the bus interface unit 309 that performs communication between the processors 302, the memory 304, a display system 324, and the I/O bus interface unit 310. The I/O bus interface unit 310 may be coupled with the I/O bus 308 for transferring data between various I/O units. The I/O bus interface unit 310 may communicate with a plurality of the I/O interface units 312, 314, 316, and 318 also known as I/O processors (IOP) or the I/O adaptors (IOA) via the I/O bus 308.

The display system 324 may include either or both a display controller and a display memory. The display controller can provide either or both video data and audio data to a display apparatus 326. In addition, the computer system 300 may include devices such as one or more sensors that are configured to collect data, and provide the data to the processors 302.

For example, the computer system 300 may include sensors such as a biometric sensor that collects heart rate data, stress level data, or the like, an environment sensor that collects humidity data, temperature data, pressure data, or the like, or a motion sensor that collects acceleration data, motion data, or the like. Other types of sensor can be used also. The display system 324 may be connected to the display apparatus 326 such as a single display screen, a television, a tablet, or a portable device.

The I/O interface units have functionalities of communicating with various storages or I/O devices. For example, a user I/O device 320 like a user output device such as a video display apparatus or a speaker television, and a user input device such as a keyboard, a mouse, a keypad, a touch pad, a track ball, buttons, a write pen, or another pointing device can be attached to the terminal interface unit 312. By operating the user input device by using a user interface, a user may input input data or instructions to the user I/O device 320 and the computer system 300, and receive output data from the computer system 300. For example, the user interface may be displayed on the display apparatus, reproduced by a speaker, printed via a printer, and so on via the user I/O device 320.

One or more disk drives or a direct access storage apparatus 322 (which typically is a magnetic disk drive storage apparatus, but may be a disk drive array configured to be seen as a single disk drive or may be another storage apparatus) can be attached to the storage interface 314. In an embodiment, the storage apparatus 322 may be implemented as any secondary storage apparatus. Contents of the memory 304 may be stored on the storage apparatus 322, and read out from the storage apparatus 322 as necessary. The I/O device interface 316 may provide an interface to another I/O device such as a printer or a fax machine. The network interface 318 may provide a communication path such that the computer system 300 and another device can communicate mutually. The communication path may be a network 330, for example.

In an embodiment, the computer system 300 may be a device such as a multi-user main frame computer system, a single user system, or a server computer that does not have a direct user interface, and that receives requests from another computer system (client). In another embodiment, the computer system 300 may be a desktop computer, a portable computer, a laptop personal computer, a tablet computer, a pocket computer, a telephone, a smartphone, or any other appropriate unit of electronic equipment.

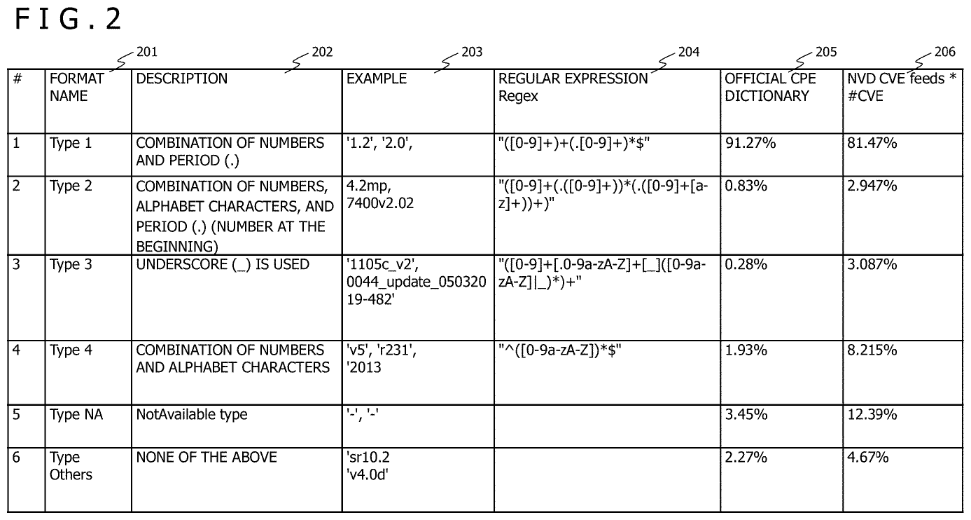

Next, types of version information according to the embodiment of the present disclosure are explained with reference to FIG. 2.

FIG. 2 is a figure depicting a version information table 200 representing version information format types according to the embodiment of the present disclosure. As mentioned above, there is not a common version name format for representing version information of software products, and different formats of software version information are used between different vendors that provide the software products, between different types of product, and so on. Hereinbelow, several formats of version information used as software information are explained with reference to the version information table 200.

The version information table 200 includes, about each version information format type, a format name 201 representing the name of the format, a description 202 representing a brief description of the format, an example 203 representing specific examples of the format, a regular expression 204 representing a regular expression of the format, an official CPE dictionary 205 representing the probability that the format is included in the official CPE dictionary, and an NVDCVE feed 206 representing the probability that the format is included in the NVDCVE feed.

As represented by the version information table 200, there are various formats such as version information “1.2” or “2.0” including only numerical values and a period, version information such as “0044_update_05032019-482” including numerical values, alphabet characters and special characters, and the like. Because of this, it is difficult to directly compare version information in different formats, and even if a software version having a vulnerability or a malfunction is found, it becomes difficult to identify software versions matching the software version, that is, software versions that are to be affected by the vulnerability, in some cases.

Accordingly, as mentioned above, the present disclosure relates to a technique that can identify a software version that needs a version update, even in a case of version information including a certain special character, by comparing check-subject software version information with reference information about a version having been found to have a vulnerability after the check-subject software version information is converted into a common structural format on the basis of predetermined structuring rules.

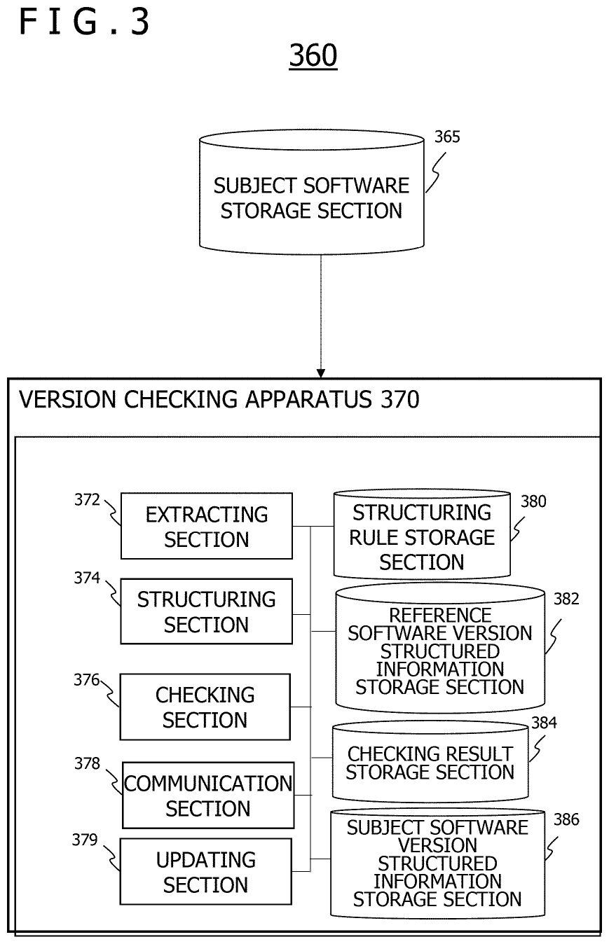

Next, the configuration of a version checking system according to the embodiment of the present disclosure is explained with reference to FIG. 3.

FIG. 3 is a figure depicting an example of the configuration of a version checking system 360 according to the embodiment of the present disclosure. As depicted in FIG. 3, the version checking system 360 according to the embodiment of the present disclosure mainly includes a subject software storage section 365 and a version checking apparatus 370. The subject software storage section 365 and the version checking apparatus 370 may be included in the same network, may be connected via a communication network such as a LAN or the Internet, or may be stored on the same hardware device.

The subject software storage section 365 is a storage section for storing a software product which is the subject of version checking. The subject software storage section 365 may be a storage apparatus such as a hard disk drive or a solid state drive mounted on an apparatus, may be a distributed storage platform such as a cloud server, and is not particularly limited in the present disclosure.

The software product stored on the subject software storage section 365 may be a software application configured to operate on a certain computing device such as a personal computer, medical equipment, vehicle-mounted equipment, or a home electric appliance. In addition, the software product includes subject software version information representing the version of the software. As an example, the software product may include, as subject software version information, a string like “1.3” including numerical values and a period, a string like “1105c_v2” including numerical values, alphabet characters, and a special character (an underscore), or the like.

As mentioned below, this subject software version information is converted into a predetermined structural format, and a similarity of the subject software version information to reference software version structured information is decided. Thereby, it is possible to easily decide whether or not the subject software needs a version update.

Note that the similarity here may be a measure that represents to what degree the subject software version information and the reference software version information match, or may represent a magnitude relation between the subject software version information and the reference software version information.

The version checking apparatus 370 is an apparatus for performing a version checking process on the predetermined software version information. As depicted in FIG. 3, the version checking apparatus 370 includes an extracting section 372, a structuring section 374, a checking section 376, a communication section 378, a structuring rule storage section 380, an updating section 379, a reference software version structured information storage section 382, a checking result storage section 384, and a subject software version structured information storage section 386.

The extracting section 372 is a functional section for extracting, from the subject software, the subject software version information representing the software version of the subject software which is the subject of version checking. For example, the extracting section 372 may extract the subject software version information representing the software version of the software product from the software product stored on the subject software storage section 365.

The structuring section 374 is a functional section for generating software version structured information obtained by conversion of the software version information into the predetermined structural format by using structuring rules that define subdivision of a string on the basis of presence or absence of predetermined characters in the software version information. The predetermined characters here may include, for example, parentheses, a period, an underscore, alphabet characters, and numerical values, but are not limited particularly, and may include any character. As mentioned below, the structural format is a common format for comparing subject software version information with reference software version information. In addition, the structuring rules for converting the subject software version information into the structural format are stored on the structuring rule storage section 380 depicted in FIG. 3.

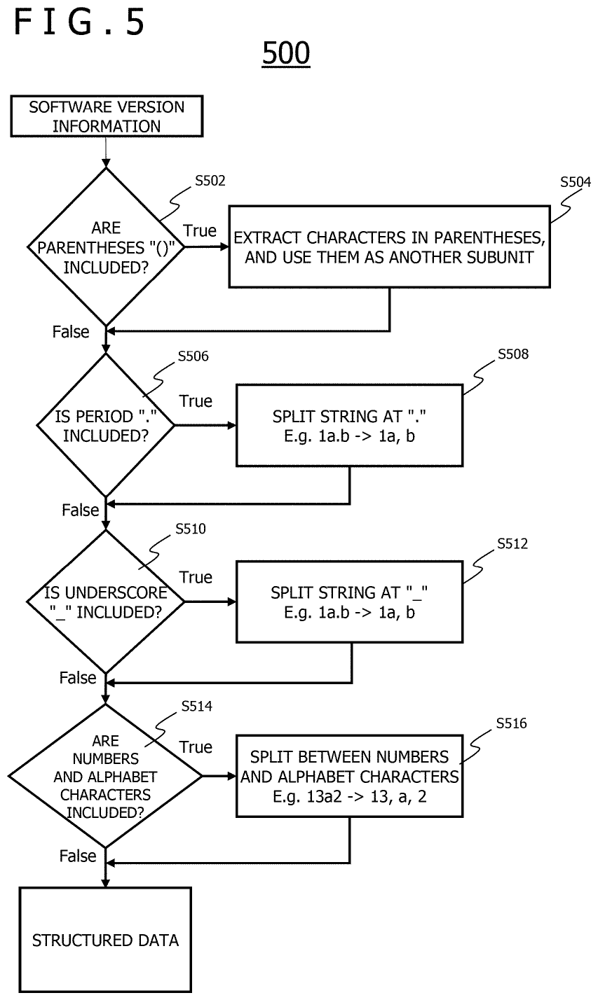

Note that details of a process for converting the subject software version information into the structural format are explained with reference to FIG. 5, and thus the explanation is omitted here.

The checking section 376 is a functional section for deciding the similarity of the subject software version structured information to the reference software version structured information representing a reference software version in the structural format by comparing the subject software version structured information with the reference software version structured information. The checking section 376 may generate a checking result representing the similarity of the subject software version structured information to the reference software version structured information, and store the checking result on the checking result storage section 384.

The checking result may represent whether the subject software version structured information matches the reference software version structured information, the subject software version structured information is older than the reference software version structured information, or the subject software version structured information is newer than the reference software version structured information. On the basis of the checking result, it is possible to decide necessity of a software version update of the subject software.

The communication section 378 is a functional section for outputting the checking result representing the similarity of the subject software version structured information to the reference software version structured information. For example, the communication section 378 may transmit the checking result to any notification destination such as the owner of the computing device on which the subject software is operating. In an embodiment, in a case where it is decided that the subject software version structured information matches the reference software version structured information or the subject software version structured information is older than the reference software version structured information, the communication section 378 may transmit an update command for updating the software version of the subject software to the updating section 379.

The updating section 379 is a functional section for updating the software version of the subject software. In an embodiment, in a case where the subject software version structured information matches the reference software version structured information or the subject software version structured information is older than the reference software version structured information, the updating section 379 may update the software version of the subject software. In an embodiment, the updating section 379 may update the software version of the subject software on the basis of the update command received from the communication section 378.

By including the updating section 379 that automatically updates the software version of the subject software on the basis of the checking result in this manner, it is possible to reduce the labor of manually updating the subject software.

The structuring rule storage section 380 is a storage section for storing the structuring rules for converting the subject software version information into the structural format. As mentioned above, the structuring rules are rules that define subdivision of strings on the basis of presence or absence of predetermined characters.

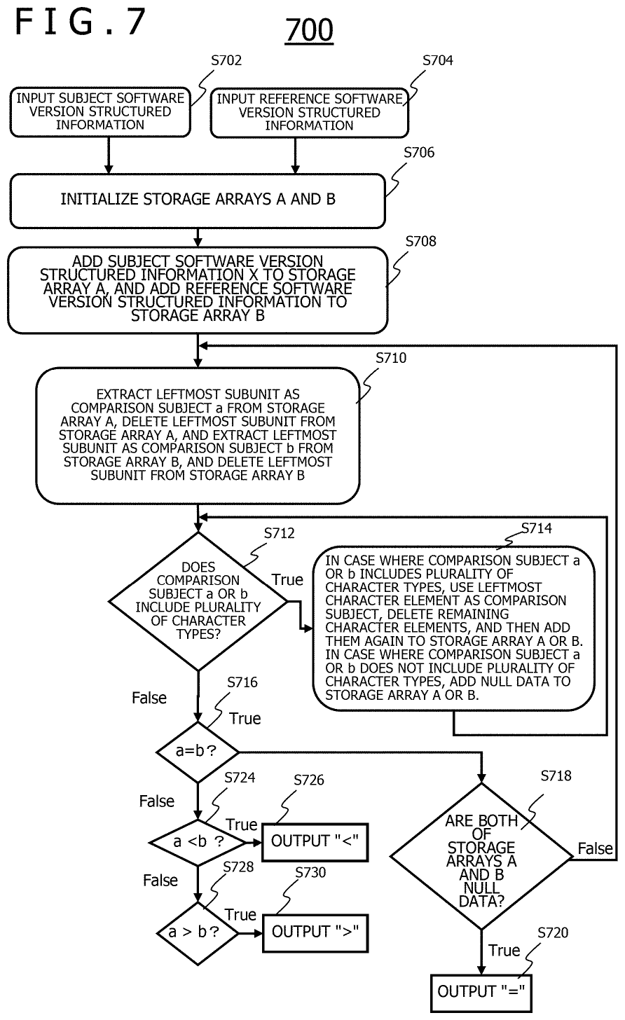

Note that details of the structuring rules are explained with reference to FIG. 7, and thus the explanation is omitted here.

The reference software version structured information storage section 382 is a storage section for storing the reference software version structured information representing the reference software version in the structural format. For example, the reference software version structured information is information representing, in the structural format, the software version having been found to have a vulnerability, and serves as information to be compared with the subject software version structured information as mentioned below.

The checking result storage section 384 is a storage section for storing the checking result obtained by comparing the subject software version structured information with the reference software version structured information. As mentioned above, the checking result stored on the checking result storage section 384 may be transmitted to a predetermined notification destination by the communication section 378, and may be used for deciding necessity of a software version update by the updating section 379.

The subject software version structured information storage section 386 is a storage section for storing the subject software version structured information obtained by conversion by the extracting section 372 of the subject software version information extracted from the software stored on the subject software storage section 365 into the structural format.

According to the version checking system 360 configured in the manner explained above, it is possible to easily identify a software product that needs a version update by checking subject software version information, and generating a checking result representing a similarity of the subject software version information to reference information about a version having been found to have a vulnerability, for example.

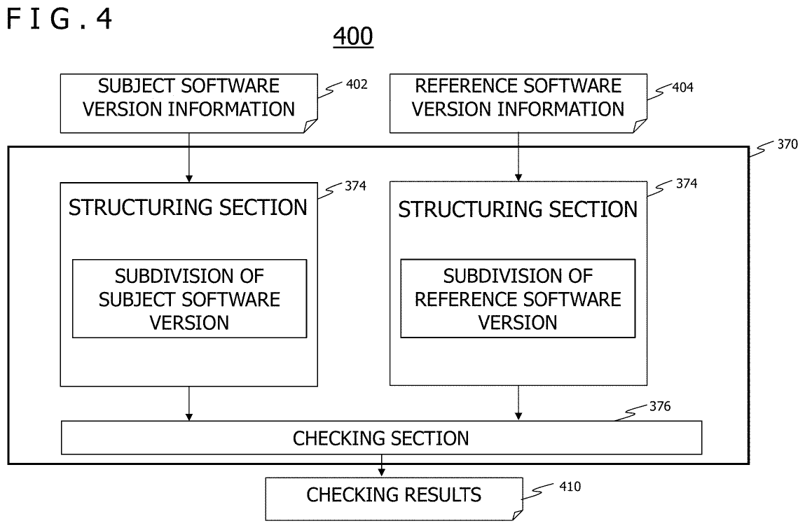

Next, the logical configuration of the version checking apparatus according to the embodiment of the present disclosure is explained with reference to FIG. 4.

FIG. 4 is a figure depicting an example of the logical configuration 400 of the version checking apparatus 370 according to the embodiment of the present disclosure.

As mentioned above, in the present disclosure, a similarity of the subject software version of the software which is the subject of checking to the reference software version can be decided by converting the subject software version information representing the subject software version into the predetermined structural format, and comparing it with the reference software version structured information representing, in the structural format, the software version of the reference software having been found to have a vulnerability, for example. Then, on the basis of the similarity, it is possible to decide necessity of an update of the subject software.

For example, in a case where, as a result of the checking, the software version of the subject software matches the software version of the reference software having been found to have a vulnerability or the subject software version structured information is older than the reference software version structured information, the software version of the subject software is desirably updated to the latest version in order to solve the vulnerability.

Hereinbelow, the overall flow of the present disclosure is explained with reference to an example of the logical configuration 400 of the version checking apparatus 370 depicted in FIG. 4.

First, as depicted in FIG. 4, the version checking apparatus 370 receives, as input, subject software version information 402 representing the software version of the subject software, and reference software version information 404 representing the software version of the reference software (e.g. the software having been found to have a vulnerability or a malfunction). More specifically, the version checking apparatus 370 may extract, from the subject software, the subject software version information 402 by using the extracting section mentioned above (e.g. the extracting section 372 depicted in FIG. 3), and acquire the reference software version information 404 from a third party database such as the CVE storing information about the software version having been found to have a vulnerability.

Next, the structuring section 374 in the version checking apparatus 370 converts each the input subject software version information 402 and reference software version information 404 into the structural format by applying the structuring rules stored on the structuring rule storage section (e.g. the structuring rule storage section 380 depicted in FIG. 3) to them.

For example, as depicted in FIG. 4, specifically, the structuring section 374 converts each the subject software version information 402 and the reference software version information 404 into the structural format by subdividing them according to the structuring rules. As a result of this process, the subject software version structured information obtained by conversion of the subject software version information 402 into the structural format, and the reference software version structured information obtained by conversion of the reference software version information 404 into the structural format are generated.

Next, the checking section 376 decides a similarity of the subject software version structured information to the reference software version structured information by comparing the subject software version structured information with the reference software version structured information, and generates a checking result 410 representing the similarity. As mentioned above, for example, the checking result may represent whether the subject software version structured information matches the reference software version structured information, the subject software version structured information is older than the reference software version structured information, or the subject software version structured information is newer than the reference software version structured information. On the basis of the checking result, it is possible to decide necessity of a software version update of the subject software.

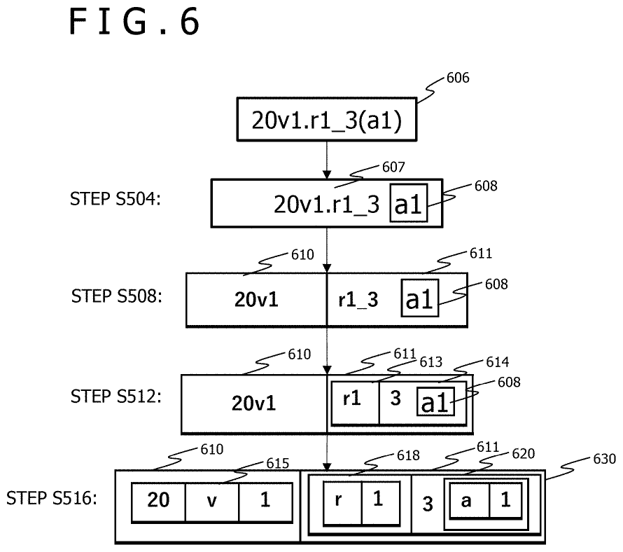

Next, a structuring process according to the embodiment of the present disclosure is explained with reference to FIG. 5 and FIG. 6.

FIG. 5 is a figure depicting an example of the flow of a structuring process 500 according to the embodiment of the present disclosure. The structuring process 500 depicted in FIG. 5 is a process for generating the software version structured information by converting the software version information into the structural format by using the structuring rules that define subdivision of a string on the basis of presence or absence of predetermined characters in the software version information. The structuring process 500 depicted in FIG. 5 converts the subject software version information mentioned above into the subject software version structured information, and also converts the reference software version information mentioned above into the software version structured information.

For example, the structuring process 500 depicted in FIG. 5 may be performed by the structuring section depicted in FIG. 3 and FIG. 4 (e.g. the structuring section 374). For example, the structuring section may execute the structuring process 500 by acquiring the structuring rules stored on the structuring rule storage section depicted in FIG. 3 (the structuring rule storage section 380 depicted in FIG. 3), and applying the structuring rules to the subject software version information.

Each of Steps S502 to S504, Steps S506 to S508, Steps S510 to S512, and Steps S514 to S516 in the structuring process 500 depicted in FIG. 5 corresponds to a different structuring rule stored on the structuring rule storage section.

Note that in the present disclosure, the expression “subdivide” means splitting a string which is software version information into a plurality of smaller groups (units, subunits, character elements).

FIG. 6 is a figure depicting an example in which the structuring process 500 according to the embodiment of the present disclosure is applied to software version information 606, and software version structured information is generated. Before the structuring process 500 is applied, a string which is the software version information 606 depicted in FIG. 6 is treated as one unit. A unit here is a data unit to which the structuring rules mentioned above are applied. One unit may include one or more subunits. The structuring rules are applied to each unit and subunit included in the string. Furthermore, one subunit may include one or more other subunits or one or more character elements. Here, a character element is a data unit including only characters of the same character type (numerical values, alphabet characters, etc.) in the string.

Hereinafter, the structuring process 500 depicted in FIG. 5 is explained with reference to an example of subdivision of the software version information 606 depicted in FIG. 6.

First, at Step S502, the structuring section decides whether or not predetermined software version information (e.g. the subject software version information extracted by the extracting section mentioned above, or the reference software version information having been found to have a vulnerability) includes parentheses. For example, in a case where the software version information 606 is “20v1.r1_3(a1)” as depicted in FIG. 6, the structuring section decides that the software version information includes parentheses.

In a case where the software version information includes parentheses, the present process proceeds to Step S504, and in a case where the subject software version information does not include parentheses, the present process proceeds to Step S506.

Next, in a case where it has been decided that the software version information includes parentheses, at Step S504, the structuring section extracts characters in the parentheses from the software version information, and treats them as another subunit. For example, in a case where the software version information 606 is “20v1.r1_3(a1)” as depicted in FIG. 6, the structuring section extracts “a1” in the parentheses from the software version information to thereby subdivide the software version information into two units, a unit 607 and a subunit 608. After Step S504 has ended, the present process proceeds to Step S506.

Next, at Step S506, the structuring section decides whether or not the software version information includes a period. For example, in a case where the software version information 606 is “20v1.r1_3(a1)” as depicted in FIG. 6, the structuring section decides that the software version information includes a period.

In a case where the software version information includes a period, the present process proceeds to Step S508, and in a case where the software version information does not include a period, the present process proceeds to Step S510.

Next, in a case where it has been decided that the software version information includes a period, at Step S508, the structuring section splits the software version information at the period. For example, in a case where the software version information 606 is “20v1.r1_3(a1)” as depicted in FIG. 6, the structuring section splits the software version information 606 at the period into “20v1” and “r1_3(a1).” As a result, the software version information 606 is subdivided into a unit 610 including “20v1,” and a unit 611 including “r1_3(a1).” In addition, as depicted in FIG. 6, the unit 611 includes the subunit 608 extracted at Step S504.

After Step S508 has ended, the present process proceeds to Step S510.

Next, at Step 510, the structuring section decides whether or not the software version information includes an underscore. For example, in a case where the software version information 606 is “20v1.r1_3(a1)” as depicted in FIG. 6, the structuring sections decides that the software version information includes an underscore.

In a case where the software version information includes an underscore, the present process proceeds to Step S514, and in a case where the software version information does not include an underscore, the present process proceeds to Step S512.

Next, in a case where it has been decided that the software version information includes an underscore, at Step S512, the structuring section splits the software version information at the underscore. For example, in a case where the software version information 606 is “20v1” and “r1_3(a1)” as depicted in FIG. 6, the structuring section splits the software version information 606 at an underscore into “20v1,” “r1,” and “3(a1).” As a result, the software version information 606 depicted in FIG. 6 is subdivided into the unit 610 including “20v1,” and the unit 611 including a subunit 613 including “r1,” and a subunit 614 including “3(a1).” In addition, as depicted in FIG. 6, the subunit 614 includes the subunit 608 extracted at Step S504.

After Step S512 has ended, the present process proceeds to Step S514.

Next, at Step S514, the structuring section decides whether or not the software version information includes mixedly present numerical values and alphabet characters. For example, in a case where the software version information 606 is “20v1.r1_3(a1)” as depicted in FIG. 6, the structuring section decides that the subject software version information includes mixedly present numerical values and alphabet characters.

In a case where there are mixedly present numerical values and alphabet characters, the present process proceeds to Step S516, and in a case where there are not mixedly present numerical values and alphabet characters, the present process ends, and the string at this time point is output as structured data.

Next, in a case where the subject software version information includes mixedly present numerical values and alphabet characters, at Step S516, the structuring section splits the software version information between a numerical value and an alphabet character. For example, in a case where the software version information 606 is “20v1,” “r1,” and “3(a1)” as depicted in FIG. 6, the structuring section splits the software version information 606 between a numerical value and an alphabet character into “20,” “v,” “1,” “r,” “1,” “3,” “a,” and “1,” and generates the thus-subdivided software version information as software version structured information 630. As a result, the software version information 606 is split into the unit 610 including a subunit 615 including character elements “20,” “v,” and “1,” and the unit 611 including a subunit 618 including character elements “r” and “1,” and a subunit 620 including character elements “3,” “a,” and “1.”

According to the structuring process 500 explained above, by subdividing the subject software version information in accordance with the structuring rules mentioned above, the subject software version structured information obtained by conversion of the software version of the subject software into the structural format for checking can be generated, and also it becomes possible to compare the software version structured information on the basis of each character element.

Note that whereas the structuring rules for performing subdivision based on parentheses, a period, an underscore, alphabet characters, and numerical values are explained as an example in the structuring process 500 explained above, the present disclosure is not limited to this, but subdivision may be performed on the basis of presence or absence of certain characters. For example, in an embodiment, predetermined characters and structuring rules may be defined on the basis of input by a user.

Next, a version checking process for checking a software version according to the embodiment of the present disclosure is explained with reference to FIG. 7.

FIG. 7 is a figure depicting an example of a version checking process 700 for checking a software version according to the embodiment of the present disclosure. The version checking process 700 depicted in FIG. 7 is a process for checking the subject software version structured information by comparing the subject software version structured information with the reference software version structured information, and deciding a similarity of the subject software version structured information to the reference software version structured information.

The version checking process 700 depicted in FIG. 7 is performed by the checking section according to the embodiment of the present disclosure (e.g. the checking section 376 depicted in FIG. 3).

First, at Steps S702 and S704, the checking section receives, as input, the subject software version structured information and the reference software version structured information. For example, here, the checking section may acquire the subject software version structured information from the subject software version structured information storage section (e.g. the subject software version structured information storage section 386 depicted in FIG. 3), and acquire the reference software version structured information from the reference software version structured information storage section (e.g. the reference software version structured information storage section 382 depicted in FIG. 3).

Next, at Step S706, the checking section initializes storage arrays A and B for storing the subject software version structured information and the reference software version structured information. A storage array here is a data structure in which data of the same type is arrayed in one line (on a memory). For example, here, the checking section may create the storage arrays A and B including NULL data (i.e. “0”) as elements on a memory reserved for the checking section on a memory of the version checking apparatus.

Next, at Step S708, the checking section adds the subject software version structured information to the storage array A, and adds the reference software version structured information to the storage array B. Thereby, NULL data in the storage arrays A and B is overwritten by the subject software version structured information and the reference software version structured information.

Next, at Step S710, the checking section extracts, as a comparison subject a, the leftmost subunit which is a subunit on the leftmost end of the storage array A, and also extracts, as a comparison subject b, the rightmost subunit which is a subunit on the rightmost end of the storage array B. Thereafter, the checking section deletes the leftmost subunit from the storage array A, and deletes the rightmost subunit from the storage array B.

For example, as an example, in a case where the structured information is “20v1.r1_3(a1),” because “20v1” is the leftmost subunit, “20v1” is extracted as the comparison subject a (the subunit 615 which is the leftmost subunit in the software version structured information 630 depicted in FIG. 6).

Next, at Step S712, the checking section decides whether or not either one of the comparison subject a and the comparison subject b includes a plurality of character types (numerical values, alphabet characters, and special characters) (i.e. is a character element). For example, in a case where the comparison subject a is “20v1,” because it includes two character types, numerical values and an alphabet character, it is decided that there are a plurality of character types. On the other hand, in a case where the comparison subject is “31,” because it includes only one character type, numerical values, it is decided that there are not a plurality of character types.

In a case where it is decided that either one of the comparison subject a and the comparison subject b includes a plurality of character types, the present process proceeds to Step S714. On the other hand, in a case where it is decided that either one of the comparison subject a and the comparison subject b does not include a plurality of character types, the present process proceeds to Step S716.

Next, in a case where it has been decided that either one of the comparison subject a and the comparison subject b includes a plurality of character types (numerical values, alphabet characters, and special characters), at Step S714, the checking section keeps, as a comparison subject, only a character element on the leftmost end in the subunit which is the comparison subject, and deletes remaining character elements. Thereafter, the deleted character elements are added again to the original storage arrays A and B. In a case where the comparison subjects no longer include a plurality of character types as a result of the process at Step S714, the checking section adds Null data to the original storage array A or B. After Step S714 has ended, the present process returns to Step S712.

For example, in a case where the comparison subject a is “20v1,” the character element “20” on the leftmost end becomes the comparison subject a, and the character elements “v” and “1” are added again to the storage array A.

Since the comparison subject can be set to a character element in this manner, it becomes possible to compare the software version structured information on the basis of each character element.

Next, at Step S716, the checking section compares the comparison subject a with the comparison subject b, and decides whether or not the comparison subject a and the comparison subject b are equal (a=b). In a case where the comparison subject a and the comparison subject b are equal, the present process proceeds to Step S718, and in a case where the comparison subject a and the comparison subject b are not equal, the present process returns to Step S724.

Next, at Step S718, the checking section decides whether or not the storage array A and the storage array B are both NULL data. In a case where the storage array A and the storage array B are both NULL data (i.e. there is no structured information other than NULL data), the present process proceeds to Step S722, and in a case where the storage array A and the storage array B are not both NULL data, the present process returns to Step S710.

Next, at Step S720, the checking section outputs information representing that the comparison subject a and the comparison subject b are equal (a=b) as a checking result. The checking result representing that the comparison subject a and the comparison subject b are equal (a=b) means that the subject software version information matches the reference software version information. In this case, if it has been known that the reference software version has a vulnerability, it is likely that the subject software version matching the reference software version also has the same vulnerability. Accordingly, in order to solve the vulnerability, the software version of the subject software is desirably updated.

In a case where the checking result representing that the comparison subject a and the comparison subject b are equal (a=b) is output, the updating section according to the embodiment of the present disclosure (e.g. the updating section 379) may automatically update the software version of the subject software to the latest software version.

At Step S724, the checking section compares the comparison subject a with the comparison subject b, and decides whether or not the comparison subject a is smaller than the comparison subject b (a<b). When the comparison subject a and the comparison subject b are compared with each other here, it is decided that alphabet characters are larger than numerical values.

In a case where it is decided that the comparison subject a is smaller than the comparison subject b, the present process proceeds to Step S726, and in a case where it is not decided that the comparison subject a is smaller than the comparison subject b, the present process proceeds to Step S728.

Next, at Step S726, the checking section outputs information representing that the comparison subject a is smaller than the comparison subject b (a<b) as a checking result. The checking result representing that the comparison subject a is smaller than the comparison subject b (a<b) means that the subject software version information is older than the reference software version information. In this case, if it has been known that the reference software version has a vulnerability, it is likely that the subject software version older than the reference software version also has the same vulnerability. Accordingly, in order to solve the vulnerability, the software version of the subject software is desirably updated.

In a case where the checking result representing that the comparison subject a is smaller than the comparison subject b (a<b) is output, the updating section according to the embodiment of the present disclosure (e.g. the updating section 379) may automatically update the software version of the subject software to the latest software version.

At Step S728, the checking section compares the comparison subject a with the comparison subject b, and decides whether or not the comparison subject a is larger than the comparison subject b (a>b). As mentioned above, when the comparison subject a and the comparison subject b are compared with each other here, it is decided that alphabet characters are larger than numerical values.

In a case where it is decided that the comparison subject a is larger than the comparison subject b, the present process proceeds to Step S730.

At Step S730, the checking section outputs information representing that the comparison subject a is larger than the comparison subject b (a>b) as a checking result. The checking result representing that the comparison subject a is larger than the comparison subject b (a>b) means that the subject software version information is newer than the reference software version information. In this case, despite the fact that the reference software version has been found to have a vulnerability, there is a possibility that the vulnerability has been solved already because the subject software version is newer than the reference software version. Accordingly, an update for solving the vulnerability is not necessarily required, and a software version update of the subject software is not executed automatically. In an embodiment, here, further checking for deciding whether or not the software version of the subject software has a vulnerability may be performed.

Hereinafter, a specific example of the version checking process 700 is explained.

In the case examined first, the subject software version information is “1.3.2,” and the reference software version information is “1.3.3.”

First, each of the subject software version information and the reference software version information is subjected to the structuring process 500 explained with reference to FIG. 5, is converted into the subject software version structured information (“1,” “3,” and “2”) and the subject software version structured information (“1,” “3,” and “3”), and is input at Step S702 and Step S704.

Next, at Step S706, a data storage array A and a data storage array B are initialized.

Next, at Step S708, the subject software version structured information is added to the data storage array A, and the reference software version information is added to the data storage array B.

Next, at Step S710, “1” which is the leftmost subunit of the subject software version structured information stored in the data storage array A is extracted as the comparison subject a, and “1” which is the leftmost subunit of the reference software version structured information stored in the data storage array B is extracted as the comparison subject b.

Next, at Step S712, it is decided whether or not the comparison subject a and the comparison subject b include a plurality of character types. Since the comparison subject a and the comparison subject b are both “1,” it is decided that they do not include a plurality of character types.

Next, at Step S716, since “1=1” as a result of comparison between the comparison subject a which is “1” and the comparison subject b which is “1,” the process proceeds to Step S718.

Next, at Step S718, since there are other remaining subunits as a result of decision as to whether or not the data storage arrays A and B are NULL data, it is decided that the data storage arrays A and B are not NULL data, and the process returns to Step S710.

Next, at Step S710, “3” which is the second leftmost subunit of the subject software version structured information stored in the data storage array A is extracted as the comparison subject a, and “3” which is the second leftmost subunit of the reference software version structured information stored in the data storage array B is extracted as the comparison subject b. Thereafter, since 3=3 as result of repeating Step S712 to Step S716, the process proceeds to Step S718.

Next, at Step S718, since there are other remaining subunits as a result of decision as to whether or not the data storage arrays A and B are NULL data, it is decided that the data storage arrays A and B are not NULL data, and the process returns to Step S710.

Next, at Step S710, “2” which is the second leftmost subunit of the subject software version structured information stored in the data storage array A is extracted as the comparison subject a, and “3” which is the second leftmost subunit of the reference software version structured information stored in the data storage array B is extracted as the comparison subject b.

Thereafter, since “2”<“3” as a result of performing Step S712 to Step S724, the present process proceeds to Step S726, and information representing that the comparison subject a is smaller than the comparison subject b (i.e. the subject software version information is older than the reference software version information) is output as a checking result. In addition, on the basis of this checking result, the software version of the subject software may be updated by the updating section.

In the case examined next, the subject software version information is “1.3.2f,” and the reference software version information is “1.3.2.”

First, each the subject software version information and the reference software version information is subjected to the structuring process 500 explained with reference to FIG. 5, is converted into the subject software version structured information (“1,” “3,” and “2, f”) and the subject software version structured information (“1,” “3,” and “2”), and is input at Step S702 and Step S704.

Note that in this case, since the subject software version information and the reference software version information match except for the last subunits (“2f” and “2”), processes until extraction of the last subunits are similar to those mentioned above. Accordingly, the explanation of the processes is omitted.

After comparison between the subunits “1” and “3” in the subject software version structured information and the reference software version structured information has ended, at Step S710, “2f” which is the leftmost subunit of the subject software version structured information stored in the data storage array A is extracted as the comparison subject a, and “2” which is the leftmost subunit of the reference software version structured information stored in the data storage array B is extracted as the comparison subject b.

Next, at Step S712, it is decided that the comparison subject a which is “2f” includes a plurality of character types, and it is not decided that the comparison subject b which is “2” includes a plurality of character types.

Next, since it has been decided that the comparison subject a includes a plurality of character types (numerical values and alphabet characters), at Step S714, the comparison subject a is set to only “2,” which is the character element on the leftmost end of the comparison subject a, and “f,” which is the remaining character element, is deleted. Thereafter, the deleted character element “f” is added again to the original storage array A.

On the other hand, since it is not decided that the comparison subject b includes a plurality of character types, NULL data is added to the storage array B. Thereafter, the process returns to Step S712.

Next, at Step S712, it is decided whether or not the comparison subject a and the comparison subject b include a plurality of character types. Since the comparison subject a and the comparison subject b are both “2,” it is decided that they do not include a plurality of character types.

Next, at Step S716, since “2=2” as a result of comparison between the comparison subject a which is “2” and the comparison subject b which is “2,” the process proceeds to Step S718.

Next, at Step S718, since there is a remaining subunit “f” in the data storage array A as a result of decision as to whether or not the data storage arrays A and B are NULL data, it is decided that the data storage arrays A and B are not NULL data, and the process returns to Step S710.

Next, at Step S710, the leftmost subunit “f” of the subject software version structured information stored in the data storage array A is extracted as the comparison subject a, and “NULL” is extracted as the comparison subject b because the data storage array B has become NULL data. Thereafter, since f>NULL as a result of repeating Step S712 to Step S716, the present process proceeds to Step S730, and information representing that the comparison subject a is larger than the comparison subject b (i.e. the subject software version information is newer than the reference software version information) is output as a checking result. In addition, on the basis of this checking result, it is decided that an update of the software version of the subject software is unnecessary.

According to the version checking process 700 explained above, it becomes possible to check not only version information including numerical values or alphabet characters, but also software version information including special characters such as parentheses or an underscore, and it is possible to perform highly flexible version checking.

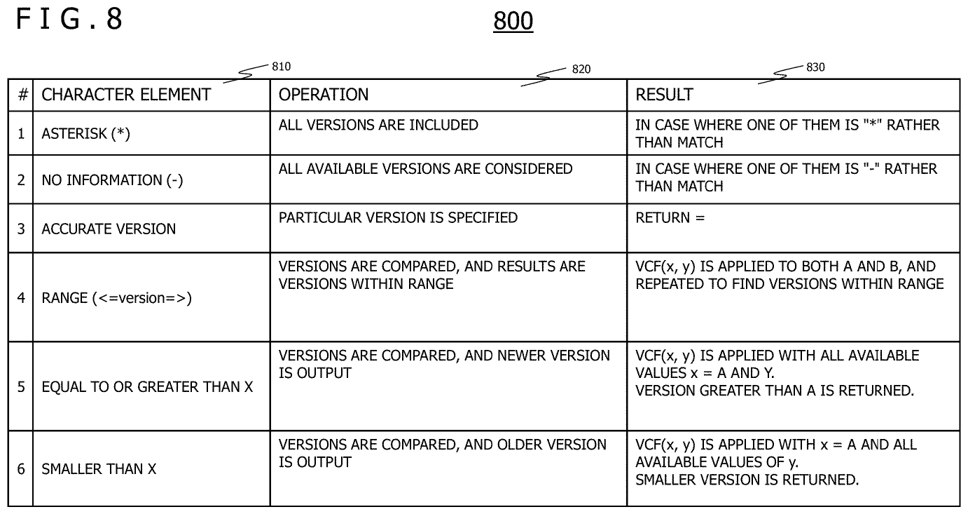

Next, a method of handling cases where there is a particular character in a string in the version checking process according to the embodiment of the present disclosure is explained with reference to FIG. 8.

FIG. 8 is a figure depicting a particular character handling table 800 representing a method of handling cases where there is a particular character in a string in the version checking process according to the embodiment of the present disclosure.

As mentioned above, in the version checking process explained with reference to FIG. 7, the subject software version structured information and the reference software version structured information are compared with each other on the basis of each character element. Whereas magnitude comparison can be performed easily in a case where each character element is numerical values or alphabet characters when the comparison based on each character element is performed, it is necessary to interpret character elements to be compared in order to perform comparison in a case where the character element is characters other than numerical values and alphabet characters. Accordingly, the particular character handling table 800 represents a method of handling cases where a character element to be compared is a particular character other than numerical values and alphabet characters.

As depicted in FIG. 8, the particular character handling table 800 represents character elements 810 representing character elements which are the subject of comparison, operation 820 specifying operation to be performed in a case where there are the character elements, and results 830 to be produced by the operation. In a case where it is decided that one of character elements which are the subject of comparison corresponds to a character element described in the character elements 810 of the particular character handling table 800, the checking section (e.g. the checking section 376 depicted in FIG. 3) that performs comparison between the subject software version structured information and the reference software version structured information executes operation 820 corresponding to the character element, and thereby can obtain a result 830 corresponding to the operation 820.

Note that whereas the particular character handling table 800 depicted in FIG. 8 represents, as an example, operation and results in cases where character elements are the asterisk, ranges or the like, the present disclosure is not limited to the character elements depicted in FIG. 8, any special character may be treated. For example, a manager of the version checking apparatus edits the particular character handling table 800, and registers new character elements and operation corresponding to the character elements. Thereby, checking that can treat any special character can be realized.

By performing comparison between subject software version structured information and reference software version structured information by using the particular character handling table 800 in this manner, the checking section can perform highly flexible version checking regarding not only version information including numerical values and alphabet character, but also special characters such as the asterisk or the hyphen, characters specifying a predetermined version range, characters specifying “equal to or larger than X,” “smaller than X” or the like, and the like.

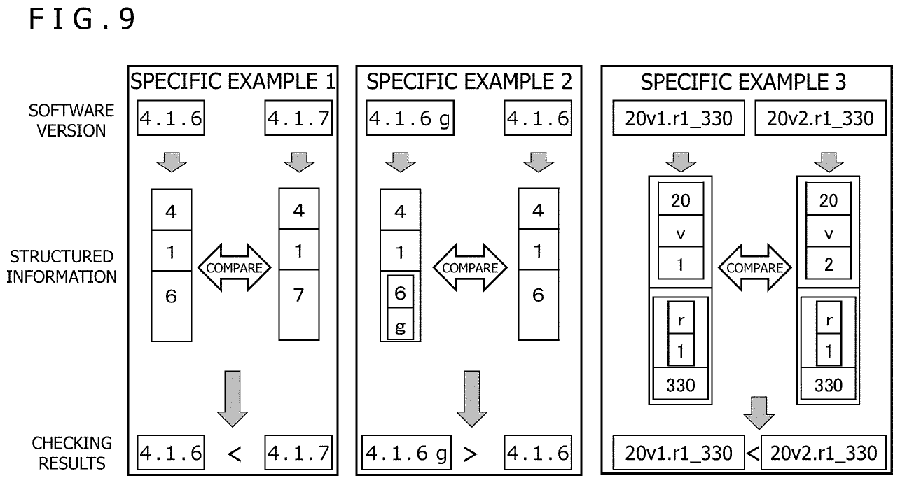

Next, specific examples of software version comparison in the version checking process according to the embodiment of the present disclosure are explained with reference to FIG. 9.

FIG. 9 is a figure depicting specific examples of software version comparison in the version checking process according to the embodiment of the present disclosure.

As mentioned above, the structuring section according to the embodiment of the present disclosure (e.g. the structuring section 374 depicted in FIG. 3) applies the structuring rules stored on the structuring rule storage section to each of input subject software version information and reference software version information to thereby convert them into the structural format. Thereafter, the checking section (e.g. the checking section 376 depicted in FIG. 3) decides a similarity of the subject software version structured information to the reference software version structured information by comparing the subject software version structured information with the reference software version structured information that are generated by the structuring section, and generates a checking result representing the similarity.

For example, in specific example 1 depicted in FIG. 9, the structuring rules stored on the structuring rule storage section are applied to each of subject software version information which is “4.1.6” and reference software version information which is “4.1.7” to thereby generate subject software version structured information including “4,” “1,” and “6,” and reference software version structured information including “4,” “1,” and “7.” Thereafter, in a case where the subject software version structured information and the reference software version structured information are compared with each other by using the checking process depicted in FIG. 7, the first two character elements that are compared starting from the left (i.e. “4” and “1”) match, and thus a checking result is determined on the basis of the last character elements (i.e. “6” and “7”). In view of this, since “6” is smaller than “7,” a checking result representing that the subject software version information is smaller than, that is, older than, the reference software version information is generated.

In addition, in specific example 2 depicted in FIG. 9, the structuring rules stored on the structuring rule storage section are applied to each of subject software version information which is “4.1.6g” and reference software version information which is “4.1.6” to thereby generate subject software version structured information including “4,” “1,” and “6, g,” and reference software version structured information including “4,” “1,” and “6.” Thereafter, when the subject software version structured information and the reference software version structured information are compared with each other, the first three character elements that are compared starting from the left (i.e. “4,” “1,” and “6”) match, and thus a checking result is determined on the basis of the last character elements. As mentioned above, in this case, the last character element of the subject software version information is “g,” but the reference software version information is “NULL.” In view of this, since “g” is larger than “NULL,” a checking result representing that the subject software version information is larger than, that is, newer than, the reference software version information, the subject software version information is generated.

Furthermore, in specific example 3 depicted in FIG. 9, the structuring rules stored on the structuring rule storage section are applied to each of subject software version information which is “20v1.r1_330” and reference software version information which is “20v2.r1_330” to thereby generate subject software version structured information including “20,” “v,” “1,” “r,” “1,” “3,” and “330,” and reference software version structured information including “20,” “v,” “2,” “r,” “1,” “3,” and “330.” Thereafter, when the subject software version structured information and the reference software version structured information are compared with each other, the first two character elements that are compared starting from the left (i.e. “20” and “v”) match, and thus a checking result is determined on the basis of the third character elements from the left (i.e. “1” and “2”). In view of this, since “1” is smaller than “2,” a checking result representing that the subject software version information is smaller than, that is, older than, the reference software version information is generated.

By performing the checking process according to the embodiment of the present disclosure after the subject software version information and the reference software version information are converted into the structural format in this manner, it is possible to easily identify a software product that needs a version update.

Whereas the apparatus, system and method for implementing version checking according to the embodiment of the present disclosure are explained above, the present disclosure is not limited to these, but may be implemented as a computer program, for example. In this case, for example, the computer program according to the embodiment of the present disclosure may be installed from a non-transitory storage medium of an external apparatus through a network, or may be installed through a non-transitory portable storage medium.

For example, in an embodiment, the version checking means according to the embodiment of the present disclosure is a version checking computer program for checking a software version, and has program instructions for causing a computing device to execute: extracting, from subject software which is the subject of version checking, subject software version information representing a software version of the subject software; generating subject software version structured information obtained by converting the subject software version information into a predetermined structural format by using a structuring rule that defines subdivision of a string on the basis of presence or absence of a predetermined character in the subject software version information; deciding a similarity of the subject software version structured information to reference software version structured information representing a reference software version in the structural format by comparing the subject software version structured information with the reference software version structured information; and outputting a checking result representing the similarity of the subject software version structured information to the reference software version structured information.

Although the present disclosure has been described with reference to example embodiments, those skilled in the art will recognize that various changes and modifications may be made in form and detail without departing from the spirit and scope of the claimed subject matter.

What is claimed is:

1. A version checking apparatus for checking a software version, comprising:
an extracting section that extracts, from subject software which is a subject of version checking, subject software version information representing a software version of the subject software;
a structuring section that generates subject software version structured information obtained by converting the subject software version information into a predetermined structural format by using a structuring rule that defines subdivision of a string on a basis of presence or absence of a predetermined character in the subject software version information;
a checking section that decides a similarity of the subject software version structured information to reference software version structured information representing a reference software version in the structural format by comparing the subject software version structured information with the reference software version structured information; and
a communication section that outputs a checking result representing the similarity of the subject software version structured information to the reference software version structured information.

2. The version checking apparatus according to claim 1, wherein
the checking result represents whether the subject software version structured information matches the reference software version structured information, the subject software version structured information is older than the reference software version structured information, or the subject software version structured information is newer than the reference software version structured information.

3. The version checking apparatus according to claim 2, further comprising:
an updating section that updates the software version of the subject software in a case where the subject software version structured information matches the reference software version structured information, or the subject software version structured information is older than the reference software version structured information.

4. The version checking apparatus according to claim 1, wherein
the predetermined character includes a parenthesis, a period, an underscore, an alphabet character, and a numerical value.

5. The version checking apparatus according to claim 4, wherein,
as the structuring rule, the structuring section extracts a character in parentheses from the subject software version information in a case where the subject software version information includes the parentheses, and treats the character as a different subunit.

6. The version checking apparatus according to claim 5, wherein,
as the structuring rule, the structuring section splits the subject software version information at a period in a case where the subject software version information includes the period.

7. The version checking apparatus according to claim 6, wherein,
as the structuring rule, the structuring section splits the subject software version information at an underscore in a case where the subject software version information includes the underscore.

8. The version checking apparatus according to claim 7, wherein,
as the structuring rule, the structuring section splits the subject software version information between an alphabet character and a numerical value in a case where the subject software version information includes the alphabet character and the numerical value that are next to each other.

9. The version checking apparatus according to claim 1, wherein
the checking section compares the subject software version structured information with the reference software version structured information on a basis of each character element included in each the subject software version structured information and the reference software version structured information.

10. A version checking system for checking a software version, comprising:
a subject software storage section that stores subject software which is a subject of version checking; and
a version checking apparatus for executing a version checking process, wherein
the version checking apparatus includes:
an extracting section that extracts, from the subject software stored on the subject software storage section, subject software version information representing a software version of the subject software;
a structuring section that generates subject software version structured information obtained by converting the subject software version information into a predetermined structural format by using a structuring rule that defines subdivision of a string on a basis of presence or absence of a predetermined character in the subject software version information;
a checking section that decides a similarity of the subject software version structured information to reference software version structured information representing a reference software version in the structural format by comparing the subject software version structured information with the reference software version structured information; and
a communication section that outputs a checking result representing the similarity of the subject software version structured information to the reference software version structured information.

11. A version checking method for checking a software version, comprising the steps of:
extracting, from subject software which is a subject of version checking, subject software version information representing a software version of the subject software;
generating subject software version structured information obtained by converting the subject software version information into a predetermined structural format by using a structuring rule that defines subdivision of a string on a basis of presence or absence of a predetermined character in the subject software version information;
deciding a similarity of the subject software version structured information to reference software version structured information representing a reference software version in the structural format by comparing the subject software version structured information with the reference software version structured information; and
outputting a checking result representing the similarity of the subject software version structured information to the reference software version structured information, wherein
generating subject software version structured information obtained by converting the subject software version information into a predetermined structural format by using a structuring rule that defines subdivision of a string on a basis of presence or absence of a predetermined character in the subject software version information includes:
extracting a character in parentheses from the subject software version information in a case where the subject software version information includes the parentheses, and treats the character as a different subunit;
splitting the subject software version information at a period in a case where the subject software version information includes the period;
splitting the subject software version information at an underscore in a case where the subject software version information includes the underscore; and
splitting the subject software version information between an alphabet character and a numerical value in a case where the subject software version information includes the alphabet character and the numerical value that are next to each other.
